(19) United States
(12) Patent Application Publication
(10) Pub. No.: US 2008/0033738 A1
(43) Pub. Date: Feb. 7, 2008

(54) Automated mail piece quality analysis tool

(75) Inventors: Walter S. Conard, Lake Villa, IL (US); Richard J. Wojdyla, Wadsworth, IL (US)

Correspondence Address: MCDERMOTT WILL & EMERY LLP, 600 13TH STREET, N.W., WASHINGTON, DC, 20005-3096, US

(73) Assignee: BOWE BELL + HOWELL POSTAL SYSTEMS COMPANY

(21) Appl. No.: 11/498,749

(22) Filed: Aug. 4, 2006

(51) Int. Cl. G06Q 99/00

(52) U.S. Cl. 705/1

(57) ABSTRACT

Quality analysis tool software executed in a computer supports mail piece quality analysis, for mail production quality assessment or quality control. The computer processes mail piece characteristic data captured by a portable device at the mail production or processing facility. The data processing identifies one or more characteristics of the sample mail piece and analyzes mail production quality by comparing the identified characteristic(s) of the sample to one or more mail piece quality requirements. A quality report, based on the comparison, may be provided to a user for use in mail production quality assessment or quality control. The computer implementing the analysis tool software may be a local device, e.g. a computer directly coupled to the data capture device or a server of the operator of the production or processing facility. Another example provides the analysis from a website server, e.g. a site operated by a quality analysis service provider.

### TECHNICAL FIELD

The subject matter discussed herein relates to a method and system for enabling mail piece quality and integrity analysis, and particularly, a quality and integrity analysis system and process operable via the web.

### BACKGROUND

For any organization that distributes millions of mail pieces via a postal authority or other mail delivery channel (e.g., the United States Postal Service—USPS), making the mail pieces automation-compatible, or machineable, is critical. Automated equipment such as sorters or inserters may be used by the mailer (an enterprise, organization or group dedicated to mail processing) and/or postal authority to segregate mail further into trays destined for a specific delivery point. The processing, performed either before or after delivery to a postal authority, is designed to prepare the mail for delivery to a postal customer. This preparation generally involves sorting the mail into trays such that each piece is in delivery sequence to make it easy for the mail delivery carrier to find the mail needed at each delivery stop. Many processing steps occur in order to achieve this result. These steps include printing a delivery point barcode that represents the delivery location on each mail piece, sorting the mail pieces into trays that are destined for the next processing center and eventually sorting to the carrier sequence. Multi-line optical character reader (MLOCR) type sorters, read the printed address, print the delivery point barcode and sort the mail by destination group. List processors perform the sorting and barcode insertion step before the mail is printed, and inserters will process the printed material to create mail pieces that are manufactured in the correct pre-sort groupings. Usage of such equipment enables mail to be processed and interpreted more efficiently, and allows the postal authority to maintain lower rates for those pieces. When mail pieces are designed and addressed such that they are automation friendly, less manual labor is required by the postal authority in distributing and delivering the mail, enabling the mailer to benefit from “work-sharing” discounts.

Mail piece design and delivery point validation/address integrity is therefore a critical aspect to consider when preparing a mailing. Consider for example a bank that wishes to send a mass credit card solicitation mailing to millions of prospective card holders. Preferably, the mailer should ensure that the addresses for the prospective cardholders are validated against current USPS address data. Furthermore, the mailer should design the mail pieces in accordance with postal authority guidelines, such as those outlined by the USPS Domestic Mail Manual (DMM), before disseminating the mailing. Design considerations for machine automation (machineable mail) may include:
Ensuring the mail pieces meet the size and weight standards defined by the DMM;
Ensuring that the addresses are readable by an OCR and that each address is that of a real delivery point; and
Ensuring that the delivery point barcode is readable and matches the address.

These, and many other design characteristics and requirements are detailed in the DMM and/or other supporting postal requirement documentation (e.g., USPS Publication 25, Chapter 2). Other postal authorities and mail processing companies have their own standards that define acceptable machineable mail.

Since postal authorities frequently offer significant postage discounts for companies to prepare the mail for easy automation and to pre-sort the mail into common delivery point groupings, the mail acceptance process has been automated with verification equipment. The USPS has installed the Mailing Evaluation Readability Lookup Instrument (MERLIN) in business mail acceptance units to perform analysis of a mailing that is presented to the USPS for work-share discounts to ensure compliance with their regulations. This equipment processes a statistically significant random sample of the mail presented for acceptance to determine if the work-share discount has been earned, usually at least 1000 mail pieces. This sample verification serves to verify compliance of the entire mailing with the applicable regulations, and thus verify entitlement to the work-share discount. If the MERLIN analysis results in loss of work-share discounts, the mailer will either have to pay additional postage or take the mail back to the facility to correct the defects. Both options are expensive.

Verification equipment also has been developed that can be installed (in-line) on inserters or sorters to verify the compliance of every mail piece to the required standards. This equipment also verifies that the acceptable error tolerances have not been exceeded for the entire mailing if errors have been detected during processing. The problem with this approach is that each mail processing machine must have the verification equipment installed and usually certified by the postal authority if mail acceptance is going to be performed based on the data collected. Due to expense and certification issues, this approach has not been widely implemented.

Another aspect of mail processing automation is to design a mail piece so that it meets automation requirements but also is automation friendly. Choice of font and font size, the location of images and advertising, the compliance of clear zones for critical items such as the POSTNET barcode clear zone, material used in the address window and choice of envelope color are a few of the features that need to be analyzed to make a mail piece automation friendly. While there are various tools for designing mail pieces with respect to the above needs, mail piece design analysis is limited to a largely manual process that relies heavily on the experience of the person doing the analysis. Mail piece design analysis is typically performed when a postal customer is designing a new business mailing. The customer wants to be sure that the mail will qualify for work-share discounts, and they want to be sure that few processing errors will occur during the automated processing of the mail that might delay delivery or even prevent delivery. Postal authorities employ Mail Piece Design Analysts (MDAs) to inspect and analyze new envelope designs to satisfy the requirements mentioned above. The MDAs in turn utilize templates, such as that shown in FIG. 5, to analyze the printed mail pieces for compliance with the design rules. The MDA also has available an envelope reflectance measurement imaging device that will determine the difference in reflectance between the print and the envelope background by analyzing an image of the area of interest on the envelope. This reflectance difference significantly impacts the address OCR read rate and the barcode read rate. The envelope reflectance measurement imaging device tool also can determine if a barcode is printed within postal authority standards. The envelope reflectance measurement imaging device has a very limited image field of view and software image processing tools.

To overcome the challenges noted above, a method and system for enabling convenient quality analysis of mail pieces is needed. The solution should offer portability, for enabling analysis from various locations, while not relying upon the manual analysis techniques employed by a MDA. Furthermore, the solution should be flexible enough to accommodate the analysis of a plurality of mail pieces concurrently, as opposed to piece-by-piece analysis, which can be too slow and reduces mail production efficiency. Finally, the solution should be easily adaptable to existing imaging equipment resident within the mailer's facility to enable greater integration and use.

### SUMMARY

Methods and systems are disclosed herein for mail piece quality analysis, for mail production quality assessment or quality control. For example, implementation of an automated mail piece quality analysis tool may help avoid the potential expense of failing a MERLIN inspection and/or the expense or difficulty in implementing a full in-line verification system.

A mail piece quality analysis method involves obtaining mail piece characteristic data, captured by sensing of a sample mail piece. Quality analysis tool software is executed in a computer, to process the mail piece characteristic data. The processing of the mail piece data entails identifying one or more characteristics of the sample mail piece and analyzing quality of mail piece production by comparing the identified one or more characteristics of the sample mail piece to one or more mail piece quality requirements stored in the computer. A report of mail piece production is generated indicating degree of compliance of the sample mail piece with the one or more mail piece quality requirements, based on a result of the comparison. The report may then be provided to a user associated with the mail piece production, for use in mail production quality assessment or quality control.

There are several different ways to obtain the mail piece characteristic data. One exemplary technique involves operating a portable data capture device in a mail piece production or processing facility to sense the sample mail piece to capture the characteristic data regarding the sample mail piece. With such an approach, execution of the analysis tool occurs in a computer associated with the mail piece production or processing facility, e.g. in a computing device directly coupled to the data capture device or in a server computer of an operator of the mail piece production or processing facility that is in communication with the portable data capture device.

Another disclosed technique for obtaining the mail piece characteristic data uses a website approach, for example, as might be implemented by a service provider offering quality analysis to a number of mail processing/production customers. This approach involves receiving the mail piece characteristic data at a website via a data network communication. In this case, execution of the analysis tool occurs in a computer associated with the website, e.g. in the web server or an associated host computer. The report is sent back to the user (from the computer associated with the website) through a data network communication to a computer of the user, for presentation to the user.

The data for the quality analysis can be captured in a number of different ways. Examples include using a scanner or the like to obtain information representing an image of the sample mail piece. Another approach is to generate information by measurement of reflectance of the sample mail piece, using an envelope reflectance measurement imaging device or the like. The analysis may also process character information, representing information read from characters or symbols printed on the sample mail piece, e.g. by OCR or BCR.

The one or more mail piece quality requirements may include postal regulations for mail piece design, similar to those checked manually by an MDA. Alternatively or in addition, the one or more mail piece quality requirements may include postal regulations for mail piece acceptance standards, such as have been verified by MERLIN in the past for work sharing discount purposes. The stored mail piece quality requirements may be automatically updated, from time to time.

As noted above, the teachings herein also encompass mail piece quality analysis systems. Several such systems are portable, for example, to facilitate use on the floor of a mail production or processing facility. The processing facility may include the production floor in a mail process factory or other related locations such as offices or data centers.

One example of a portable system for performing mail piece quality analysis includes a data capture device for sensing a sample mail piece to capture characteristic data regarding the sample mail piece. In this system, the data capture device is portable. The system also includes a portable computing device coupled to the data capture device to receive the captured characteristic data regarding the sample mail piece. Quality analysis tool software is stored in and executable by the portable computing device. Execution of the analysis tool software enables the computing device to identify one or more characteristics of the sample mail piece from the mail piece characteristic data and analyze the sample mail piece by comparing the one or more identified characteristics to one or more mail piece quality requirements. The computing device then generates a report of the quality of mail piece production, indicating degree of compliance of the sample mail piece with the one or more mail piece quality requirements, based on a result of the comparison.

In the first example of a portable system, the quality analysis tool software was resident in the portable computing device coupled to the data capture device. However, the present teachings also encompass arrangements in which the software runs on a remote computer.

Another example of a portable system for mail piece quality analysis system includes a portable data capture device and a portable data device coupled to the data capture device. However, in this example, the portable data device is configured to receive the captured characteristic data regarding the sample mail piece and forward that data to a computer, which implements quality analysis tool software to analyze the sample mail piece characteristic data for compliance with one or more mail piece quality requirements. The portable data device also receives and presents to a user a report relating to quality of the sample mail piece based on level compliance with the one or more mail piece quality requirements.

Another aspect of the teachings in the detailed description below relates to a web based mail piece quality analysis service provider system. This system includes a data interface for communication via a network, a programmable processing unit coupled to the data interface, and storage, coupled to the processing unit. The storage contains programming for the processing unit, including quality analysis tool software, as well as data regarding one or more mail piece quality requirements. Execution of the programming enables the system to provide a website user interface via network communication. The system receives characteristic data regarding a sample mail piece, via the website user interface, from a data capture device that has sensed the sample mail piece. The system identifies one or more characteristics of the sample mail piece from the characteristic data and analyzes the sample mail piece by comparing the one or more identified characteristics to one or more mail piece quality requirements from storage. Via the website user interface, the system provides a report indicating degree of compliance of the sample mail piece with one or more mail piece quality requirements, which is based on a result of the comparison.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawings depict one or more implementations in accord with the present teachings, by way of example only, not by way of limitation. In the FIGS., like reference numerals refer to the same or similar elements.

FIG. 1 depicts an exemplary scheme by which mail piece quality and design analysis may be performed locally;

FIG. 2 depicts an exemplary scheme by which mail piece quality and design analysis may be performed remotely;

FIG. 3 depicts an exemplary process for performing mail piece quality analysis;

FIG. 4 depicts a mail piece having printed thereon various address components; and

FIG. 5 depicts a tool usable for performing mail piece quality analysis manually.

### DETAILED DESCRIPTION

As used herein, the term “mail piece” refers to any document having human or machine readable content generated thereon, and particularly that intended for delivery to a given recipient. The human or machine readable markings may be referred to as address components, and may include but are not limited to barcodes, zipcodes, destination addresses, internal destination points, postal authority distribution data, key line specifications, postage information, etc. In the context of a general mailing facility, mail pieces may include envelopes, newsletters, newspapers, magazines, post cards, packages of varying thicknesses (e.g., flat mail), coupon booklets, brochures, and any other like documents. Such documents may or may not be generated for the purposes of being distributed via a distribution channel (e.g., delivery company, postal authority), but rather, may be generated for direct/personal carry, delivery, or internal distribution. When a plurality of such mail pieces are generated for distribution by a mailer, such as during a job run by a document processing device, the collection of mail pieces is referred to as a “mailing.”

A “document processing system” refers to any high speed transport device(s) capable of processing documents at considerably high rates with considerably high precision. For mail pieces, document processing systems may include, but are not limited to, inbound sorting equipment, outbound mail sorting equipment, and even various forms of inserter machines, mail integrity systems, or the like for office, commercial, or industrial settings.

Document processing systems may employ the usage of various inline (integrated) analysis and mail piece integrity tools and devices, including readers operating in conjunction with intelligence (e.g., software or firmware) for performing optical character recognition (OCR) of address or other printed character components or barcode recognition (BCR) of the various address character components of a mail piece, or envelope reflectance measurement imaging devices for detection of paper quality and reflectivity. While the discussion herein will present the teachings in an exemplary fashion with respect to such devices for mail piece quality analysis, it will be apparent to those skilled in the art that the teachings may apply to inline (integrated) or offline (standalone) operation or versions of such devices and tools. Indeed, the present teachings may be employed in any fashion compatible with the needs of the entity and/or user desiring mail piece quality analysis capability.

In process automated mail piece quality inspection is a growing requirement in the mail processing industry due to increased automation and impact on mail processing expense if the mail is not prepared in accordance with specifications. The automated mail piece quality analysis tool will be used by a variety of users. These users include but are not limited to mail manufactures, pre-sort operations, private posts, and postal authorities. The tool will be used from design of the mail piece through production and subsequent processing.

With this in mind, the following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. Those skilled in the art will appreciate that the exemplary teachings provide a convenient means for performing mail piece quality analysis—a determination as to the conformity of mail piece design and/or address component accuracy with respect to postal authority regulations. Specifically, it will be appreciated that such capability may be performed by the mailer directly or indirectly without reliance upon manual analysis by an MDA with his or her myriad of analysis tools.

A new piece of equipment, an automated mail piece quality analysis tool, is introduced to overcome the potential expense of failing a MERLIN inspection or implementing a full in-line verification system. The hardware for the tool includes a data capture device for obtaining or measuring relevant data by sensing of a sample mail piece. Typically, a local computer or other data processing device is associated with the data capture device, although the data processing device may be a communication interface, e.g. LAN card or modem, to communicate with a remote computer. The local computer may run software to analyze the captured data for mail piece quality analysis, or the data communication interface may forward the data to a remote processor system that runs the analysis software. The data capture device can be a relatively small portable device. The associated computer or communication interface also may be relatively small, e.g. a laptop or handheld PC or a modem or LAN card. The data capture device alone or even in combination with its associated computer or data communication interface thus provides a portable tool (e.g. moveable on a cart or by hand), which may be used in and moved about the mail preparation/processing facility for sampling, etc. regarding quality analysis functions.

By introducing a portable quality analysis tool that can be used in a manufacturing environment where a single individual can carry or move the equipment on a small cart to the mail processing line, in process quality checks can be made by removing a mail piece from production, testing the mail piece and returning it to the correct processing group (presorted group). Data characterizing one or more sample mail pieces is captured by sensing or measuring the mail piece(s). Characteristics of the sample(s) are identified from the data and compared to criteria or requirements defined by application postal rules/regulations, in order to determine level of compliance. By automating this process, all features of the mail piece that are visible or otherwise detectable on the piece can be quality tested by sensing the mail piece and processing the sensory data with automated quality analysis software. The quality testing may include either the parameters effecting acceptance of the mailing by the postal authority or the parameters normally checked by the MDA or both. Without the automated mail piece quality analysis tool, only a visual inspection by a person would be possible without interrupting production. The visual inspection could not include any analysis of the printed material since the postal authority standards are very precise in nature. The inspector would be limited to simple items such as, determining whether or not a delivery point barcode is printed on the mail piece. The tool generates a report of sample quality, and thus representing expected quality of the mail run from which the sample was taken. A user or operator of the production/processing facility can use the report for quality assessment and/or control purposes. For example, if the report shows deficiencies or failures to meet one or more applicable rules, the operator may be able to modify the production or processing to correct the deficiency.

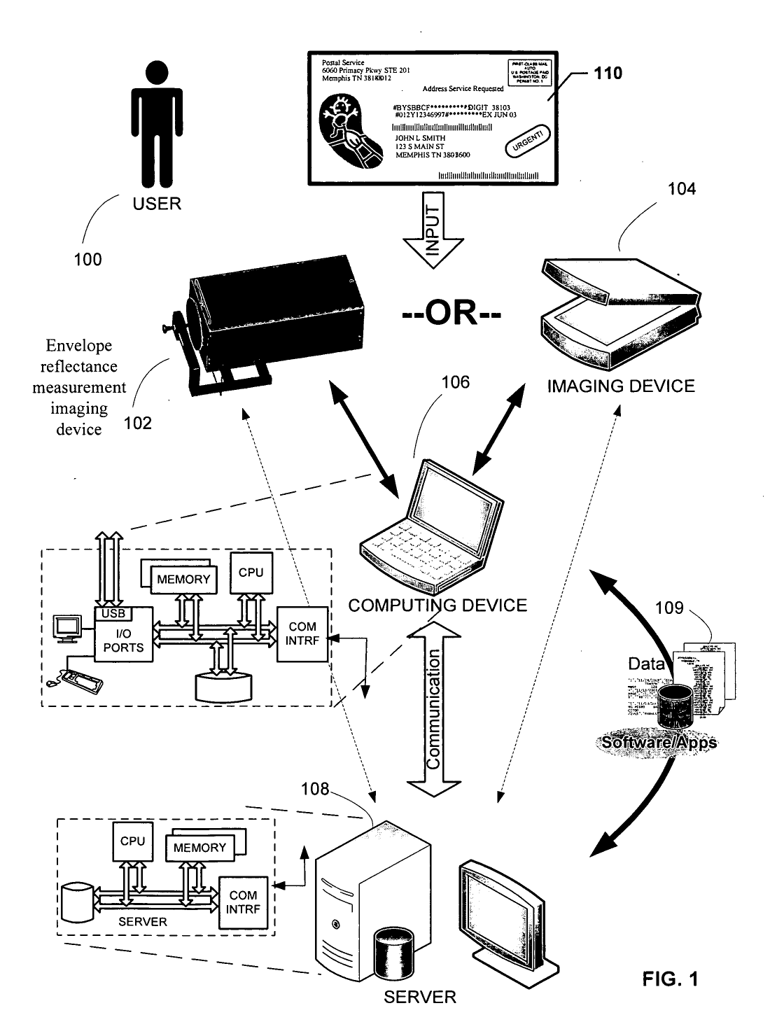

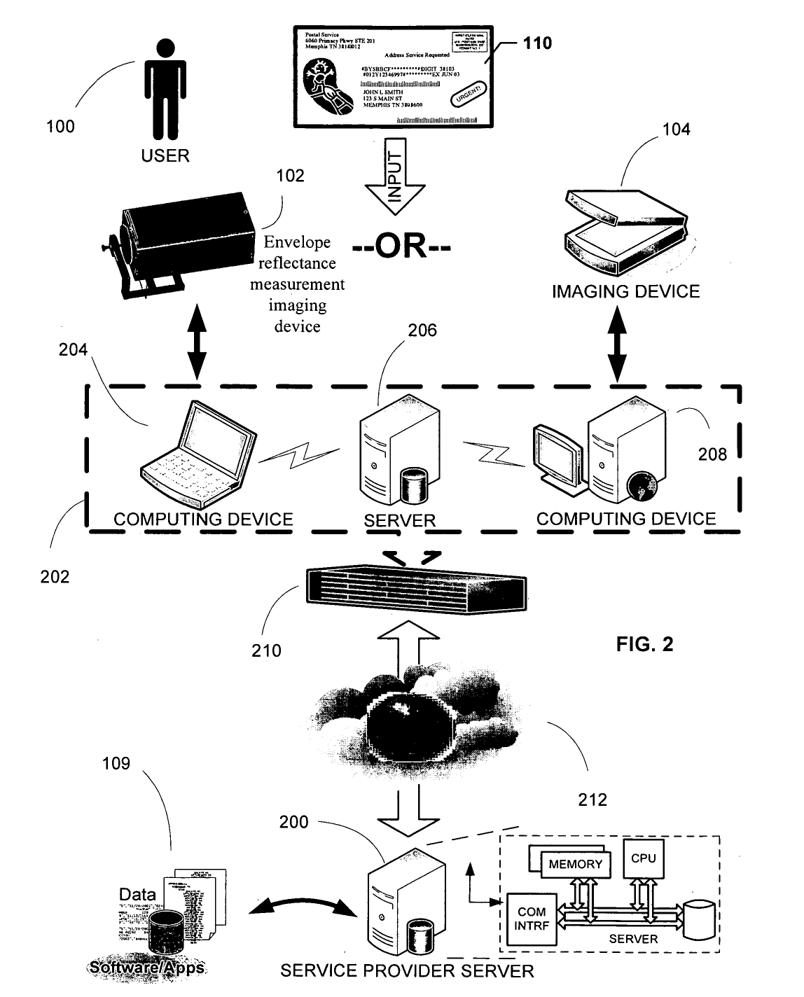

The automated mail piece quality analysis tool described herein will be configured in two primary modes. The first is a stand alone mode depicted in FIG. 1. The second is a Web connected mode depicted in FIG. 2. In the stand alone case , all of the quality analysis software is loaded on the tool. The software will generally have to be updated at least monthly due to changes in postal authority rules and requirements. For the Web connected version, the tool will be limited to image lift and transfer over the web for quality analysis. This configuration saves the user from having to keep the software current and enables the intervention of an analysis person at the remote site if a particularly difficult quality or design issue occurs.

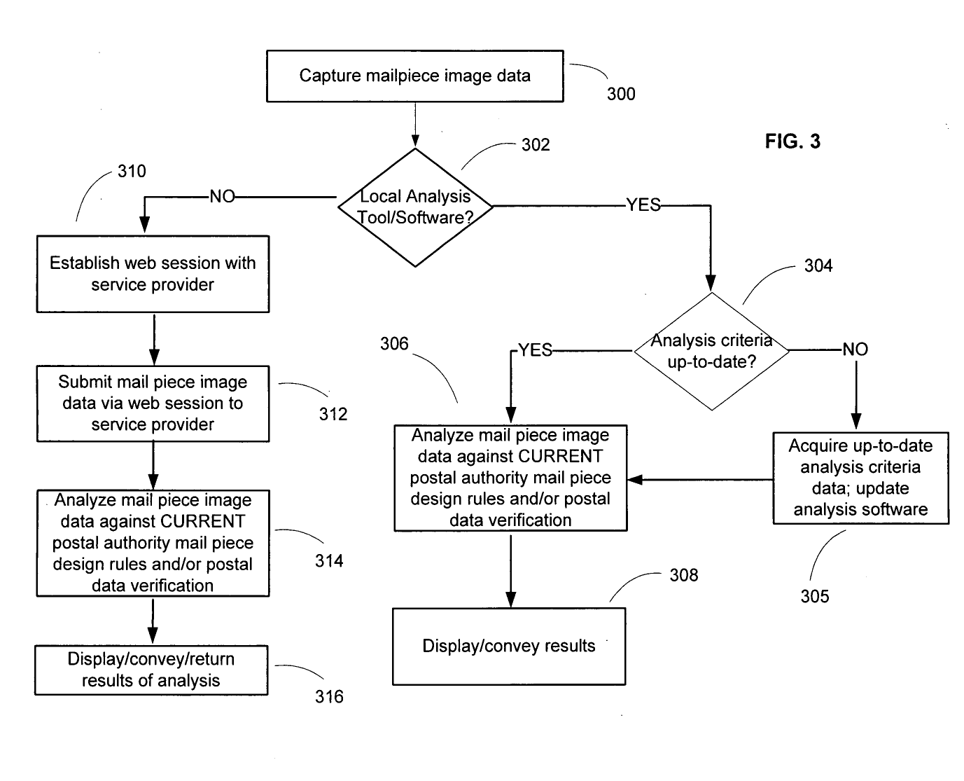

The description now proceeds with a discussion of FIG. 1, which depicts an exemplary scheme whereby a user accesses local quality analysis tools made available for operation by the user, the mailer, or the enterprise for which the mailer is affiliated, to perform mail piece quality analysis. Reference is also made to FIG. 3, a flowchart depicting the mail piece quality analysis process.

A user 100, such as an operator of a mail production machine (e.g., inserter) or other representative of a mailer, provides as input a mail piece 110 that is to be analyzed for quality (event 300, FIG. 3). The mail piece 110 may be singularly produced as a test piece prior to the generation of a full scale mailing, or may be one of a plurality of mail pieces of an existing mailing. The mail piece 110 is provided as input for an imaging device or optical device, such as a camera, envelope reflectance measurement imaging device 102, scanner 104, reader, or the like. In the example of FIG. 1, the imaging/optical type data capture device is shown to be an envelope reflectance measurement imaging device or a scanner. An envelope reflectance measurement imaging device is a tool used to measure optical properties such as but not limited to reflectance and print contrast ratio (PCR); properties which enable mail pieces to be properly detected by postal authority automation equipment—i.e., optical character recognition (OCR) readers and barcode readers. Reflectance is a measure of the mail piece's ability to reflect light, while PCR is a measure of the contrast between the background and the printed address components resident upon the mail piece 110. Reflectance, PCR, and other properties may vary depending upon the type and color of material utilized to construct the mail piece 110. Of course, those skilled in the art will recognize that envelope reflectance measurement imaging devices and scanners are well known, and in no way are presented herein as a limitation as to the type of imaging/optical device that may be employed by the mailer. Indeed, any device capable of capturing optical, image, character, spatial, material and other mail piece characteristic data is within the scope of the teachings.

Once the image and/or optical data representative of the mail piece 110 is collected, the data is passed on to a computing device for storage and/or subsequent processing. The example of FIG. 1 assumes that the user 100 has local access to mail piece quality analysis software 109. The processing at this time (YES branch after 302 in FIG. 3) may be performed in one of two ways, both of which correspond to the user 100 having local availability to mail piece quality analysis software.

In a first example with local analysis software availability, the mail piece data is passed on to a directly coupled computing device 106, which in may be a laptop computer having stored and operable thereon mail piece quality analysis software 109. A simple functional diagram of representative elements of such a PC type data processing device 106 appears in the drawing. A detailed discussion thereof should be unnecessary at this point, as artisans should be familiar with such hardware. The term “directly coupled device” refers to any computing device that is connected to the chosen mail piece characteristic data capture device 102 or 104, such as through a known peripheral I/O port (e.g., serial, USB, wireless or infrared port connection in the case of some scanners).

As a second local availability example, the directly coupled computing device 106 does not have stored thereon the mail piece quality analysis software 109. The directly coupled data device may again be a PC or a data communication interface similar to that shown in the PC. Hence, the directly coupled data device is capable of interfacing with or communicating with an enterprise application server computer 108—a device for enabling multiple connected devices within an enterprise to access a shared resource over a network (e.g., the mail piece quality analysis software 109). A simple functional diagram of a server implementation of the data processing device 108 appears in the drawing. A detailed discussion thereof should be unnecessary at this point, as artisans should be familiar with such hardware. The user devices, such as the directly coupled computing device 106 and/or any other user terminal that may receive a report, operate as client devices with respect to the server 108.

The interface and/or communication between the directly coupled computing device 106 and the application server computer 108 may be transacted via any known means allowable by the enterprise, including via an intranet or peer-to-peer connection. Likewise, the interface and/or communication may be transacted via any appropriate land line communication link or a wireless protocol/communication channel (e.g., WiFi or Bluetooth) or the like, serving to provide network communications between the devices 106, 108.

This second configuration may be preferred for large facilities with many mail processing lines. If the quality analysis is performed on the server 108, then software updates are only required on the system 108. However, the wireless connectivity may slow down processing since the image may take a long time to transfer, and a longer time may be required for the results to be reported back. If the overall delay for the quality analysis is long, then it will be more difficult to return the mail piece to the correct place in the processing line, such as a specific mail tray.

Those skilled in the art will recognize that the above described directly coupled computing device 106 may be the application server 108 device itself. In other words, if the application requirements, accessibility and/or flexibility of the user 100 or enterprise for which the user is affiliated allows, the envelope reflectance measurement imaging device 102 or scanner 104 may be directly coupled to the enterprise application server computer 108; enabling the server 108 to process the image data (via the mail piece quality analysis software 109) without the influence or presence of any intermediate computing devices (e.g., the user's computing device 106). As another consideration, the computing device 106 may also be remotely connectable to the enterprise application server 108 using a virtual private network connection (VPN) or the like for accessing the analysis software 109. Of course, various other permutations of the teachings may be contemplated by those skilled in the art.

Once the mail piece characteristic data is received, a check may be performed by the user 100 or by the mail piece quality analysis software/tool 109 (e.g., via an auto-update agent) to determine if the analysis criterion is current (event 304, FIG. 7). If the analysis criterion needs to be updated, up-to-date analysis criteria are acquired (event 305). This update can be over the network but frequently has to be done through a DVD or CD Rom due to the size of the files needed for an update. This is fulfilled by requesting current postal authority mail piece design specifications and/or current postal authority address data (e.g., recognized addresses and zip list), such as directly from the postal authority. Update frequency may vary, as differing postal authorities or jurisdictions may update their data at different times to accommodate changes. As is well known to those skilled in the art, data of this nature may be acquired electronically, such as in the case of National Change of Address (NCOA) data maintained by the USPS NCOA server. Design specification data (e.g., letter mail address component placement and dimension data) may also be obtained relative to current USPS postal regulations.

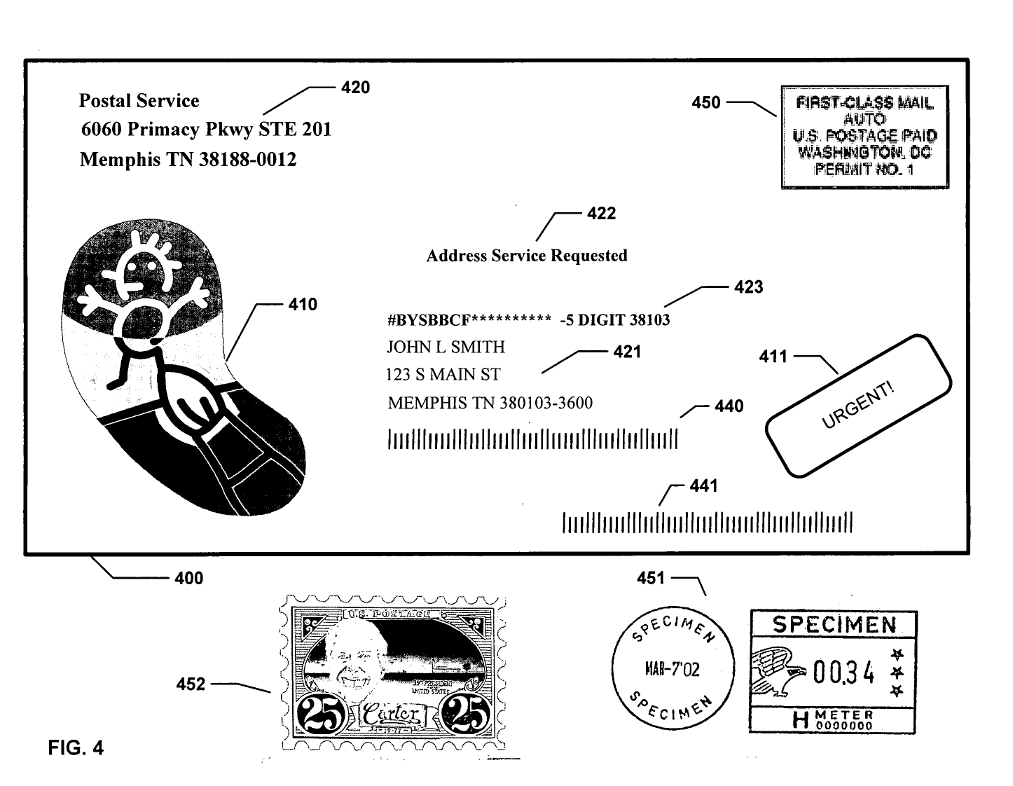

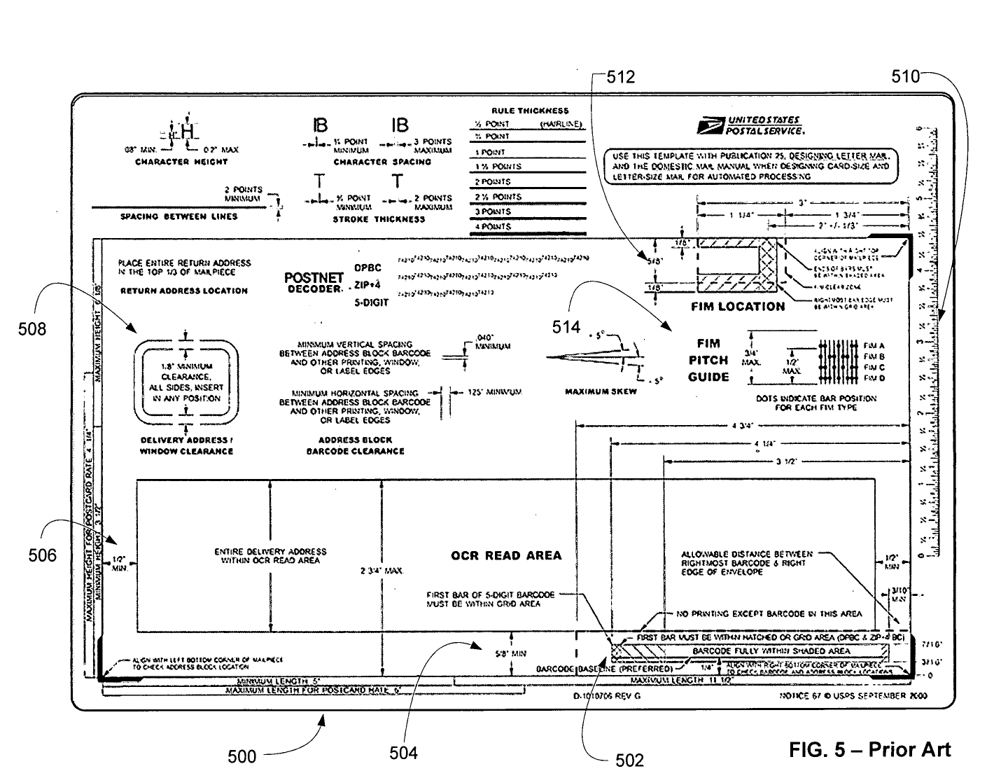

Having confirmed or acquired the up-to-date analysis criteria data, the mail piece design analysis software 109 may be updated as well, after which the analysis process is performed on the mail piece characteristic data (event 306). This essentially involves processing the data to identify relevant traits or characteristics of the sample mail pieces. The identified traits are compared to requirements or criteria defined by the applicable postal rules. An exemplary computerized quality analysis is discussed in detail later with regard to FIGS. 4 and 5. After the analysis is complete, the results of the analysis are conveyed to the user 100, such as in the form of an analysis report via print, e-mail notification, or rendered to the monitor of the computing device 106 or other client workstation, corresponding to event 308 in FIG. 3.

The clear advantage of the automated mail piece quality analysis tool is the large number of quality checks that can be performed as part of production or the ease of doing numerous mail piece design trade-offs that can be performed quickly and efficiently without involving a postal authority employee (MDA). However, full-blown in-line verification of a mailing is not required.

A listing of some of the quality checks that can be performed with the automated mail piece quality analysis tool are: (reference FIG. 4 and Table 1)
Address quality—font, size, location, format 421
Address block barcode 440, POSTNET barcode 441, PLANET barcode quality
Move update
Address correction service print quality 422
Key line print quality and information content 423
Reverse address lookup—does the POSTNET barcode and address agree
Indicia present and readable 450, 451, 452
Return address quality 420
Print contrast ratio
Impact of images 410
Impact of additional text on envelope 411
Clear zone adherence

Those skilled in the art will recognize that this is a limited listing of parameters that can be identified and analyzed on a newly designed envelope or on an envelope that is in the automation process. FIG. 5 highlights some of the additional features, as will be discussed later.

As a capability to fulfill a function for the enterprise, the mailer, or user, but not expressly maintained or provided by either of these entities directly, the analysis capability may be provided as a service in accordance with a service and/or use agreement (e.g., subscription service, billing arrangement, contractual agreement, click charge arrangement, partnership agreement, etc.). Turning now to FIG. 2, and with reference again to FIG. 3, another exemplary scheme for performing mail piece quality and design analysis is shown. In particular, the exemplary scheme involves the usage of a web based mail piece quality analysis service provider (hereafter referred to as “service provider”) as a resource for performing the analysis. As such, the exemplary teaching depicted by the figures contemplates an analysis process or tool (e.g., mail piece quality analysis software 109) that is not expressly maintained or provided by the mailer, the mailer's enterprise, by the user, or any entity requiring such functionality.

As before, the user 100 provides the mail piece 110 as input to the envelope reflectance measurement imaging device 102 or scanner 104, and the mail piece characteristic data is captured (event 300). Coupled to the envelope reflectance measurement imaging device 102, scanner 104, or any other device for capturing mail piece characteristic data is a directly coupled computing device 202. Various devices may be employed as the directly coupled computing device 202, such as a laptop computer 204, a network server (e.g., Internet server 206) or standard office computing device 208. In instances where the laptop computer 206 or desktop computer 208 are not able to communicate over the web, such as through a firewall 210, the Internet server 206 may act as a proxy device for enabling such communication. It should be apparent that the hardware of the computers 204, 206, 208 should be similar to that of computers 106, 108 in FIG. 1, and further illustration/discussion is omitted here. Suffice it to say, any means by which the user may access the Internet and/or initiate communication over the web 212 is within the scope of the present teachings.

Having acquired the mail piece characteristic data (event 302), the process flow at 302 progresses to event 310 because there is no local quality analysis tool software available to this particular mailer. Hence, the user 100 then initiates a web session with the service provider 200 to request that a mail piece quality analysis be performed (event 310). Again, the request is made in lieu of performing the analysis via the utilization of an enterprise available mail quality analysis tool, as discussed above relative to FIG. 1.

The service provider 200 will operate a server. A simple functional block diagram appears in the drawing in association with the server, to generally represent components of the web site server. The hardware of the server may be similar to that of other computers discussed herein. However, the server is connected to the Internet for world wide web type data communications. The server runs an operating system and a website program and stores data for web pages so as to implement the service provider's web site. For the quality analysis, the server or another computer associated with the server runs the quality analysis tool software 109. User devices, such as computers like 204 and 208, will run client software, such as a client browser program, so as to operate as client devices with respect to the web server of the service provider 200. The server thus provides a website user interface accessible by a browser or other appropriate client program running on a user's terminal device.

Establishment of the web session may include, but is not limited to, the entering of a login key or password, user name, billing information, profile information, service type to be performed, etc (event 312). Once the user is granted appropriate access to the service provider website (maintained by at least a service provider server 200), the user 100 submits the mail piece characteristic data representative of the mail piece 110 for analysis (event 314). The service provider server 200 has a display system attached that can be used by an analysis to review quality tool results or consult with the user 100 if the automated analysis sofware does an insufficient analysis on a particular image.

Alternatively, the user 100 can submit multiple instances of mail piece characteristic data representative of a plurality of differing mail pieces—i.e., a plurality of images of differing mail pieces. In this way, the mail piece quality analysis service provider 200 may analyze the quality of multiple mail pieces concurrently and/or simultaneously during a single web session, as opposed to conducting a separate analysis of each mail piece individually via multiple separate sessions. If the operational concept does not require near real time response, other modes of operations can be implemented for quality analysis. For example many mail processing systems such as sorters or inserters have imaging systems as an integral part of the system for sorting functions or production control. These imaging systems are capable of storing a sampling of mail piece images that could be processed through the automated mail piece quality analysis tool at a later time in order to maintain a record of quality performance for Mail Piece Total Quality Management MPTQM or for ISO 9001. If the processor106 or 108 is sized correctly, the batch mode could be run either locally (FIG. 1) or over the web (FIG. 2).

Returning to the service provider example of FIG. 2, having submitted the mail characteristic data—a single instance or multiple instances thereof—the data is analyzed by the mail piece quality analysis service provider 200 (event 316). As described before, mail piece quality analysis software 109 may be employed for performing the analysis and result generation. However, in this example, the software 109 runs on a server or other computer 200 operated by the service provider. Upon processing the data, the results are conveyed to the user, such as by rendering a graphical analysis report to the monitor of the user's chosen directly coupled computing device 202 (event 316). In the case where multiple instances of mail piece characteristic data are submitted by the user 100 for analysis, a compiled report indicative of the totality of mail pieces that underwent analysis may be rendered to the user's monitor, or alternatively, separate reports may be provided for each mail piece for which data was submitted. Still further, the results may be communicated via e-mail, by way or print, or some other reporting means. Regardless of how the results are conveyed, those skilled in the art will appreciate the ability to receive an analysis of multiple instances of characteristic data during a single web session. Other advantages to such functionality include but are not limited to, enabling the user to consolidate the time and work required for performing individual mail piece analysis and enabling the user to specify—on demand or in advance—which of the instances of mail piece characteristic data are to be analyzed during the session (e.g., address quality for the first instance or mail piece versus mail design quality for the second instance or mail piece). It will also be noted by those skilled in the art that the ability to perform mail piece quality analysis by means of a web based process enables much user convenience and functional portability, while eliminating reliance upon a mail piece design analyst (MDA).

Turning now to FIG. 4, an example of a mail piece 400 capable of being analyzed in accordance with the teachings presented above is depicted. As indicated, mail piece quality analysis software or tools—available directly or indirectly to the mailer, enterprise or user—may be utilized for performing the quality analysis. The quality analysis software 109 operates somewhat differently, for processing different types of characteristic data obtained from different types of reading equipment, e.g. full image data from a scanner or the like as opposed to data read from the mail piece by OCR, EMR, BCR or the like. For example, the mail piece characteristic data may include image data, reflectance data (as captured by the envelope reflectance measurement imaging device), etc. The image data may be used to perform mail piece design analysis calculations (e.g. to validate the mail piece design for compliance to a template). Image data may also be used to perform barcode quality analysis calculations (e.g., does the POSTNET barcode match the delivery address block data, does the barcode meet minimum and maximum height requirements). Image data may also be used to perform Delivery Point Validation (DPV) by comparing the image of the delivery point address block against current USPS address lookup tables. Envelope reflectance measurement imaging device reflectance data may be used to calculate print contrast ratio, or reflectance quality. However, if printed data was read from the mail piece by OCR, EMR, BCR or the like, the software can generally determine if the printed data was readable (as indicated by successful OCR or BCR) and can compare address and/or bar code data to known valid data to confirm validity of the printed data components.

Table 1 below indicates various mail piece quality analysis criteria by which a mail piece may be analyzed, and of course, by which the software may be adapted to perform analysis processing of the mail piece 400. Accordingly, the mail piece characteristic data acts as the input necessary for which to engage the below listed criteria. So, for example, an image representative of mail piece 400 can be provided as input to the mail piece analysis software, and then the image may be evaluated against the various points of analysis indicated in the table.

TABLE 1
Various types of mail piece quality analysis criteria

| | | |
|---|---|---|
| Item No. | Analysis Title | Overview of Analysis |

POSTNET Barcode

| | | |
|---|---|---|
| 1 | Digit String Analysis | Checking proper use of default characters; i.e. 00 |
| | | and 99 (if barcode is in the address block) |
| 2 | Barcode Readability | Bar by Bar and Global bar measurements as |
| | | compared to MERLIN threshold measurements |
| 3* | Location on Mailpiece | Measuring the distance from the barcode to edge of |
| | | the mailpiece and comparing to MERLIN threshold |
| | | measurements |
| 4 | Decode Characters (check | Decoding the value of the string of bars checking: |
| | digit verified) | check digit, character/bar count, framing bars |
| 5 | Standardize address for the | Performing a reverse lookup. USPS product, ZI |
| | barcode | Dialog, will produce the standardized address from |
| | | an 11-digit barcode. (If barcode is in the address |
| | | block) |

PLANET Barcode

| | | |
|---|---|---|
| 6 | PLANET Barcode | Bar by Bar and Global bar measurements as |
| | Readability | compared to MERLIN threshold measurements |
| 7 | PLANET Accuracy | Validates Subscriber ID, Destination Confirm |
| | | Service, Origin Confirm Service |
| 8* | Location on Mailpiece | Measuring the distance from the barcode to edge of |
| | | the mailpiece and comparing to MERLIN threshold |
| | | measurements |
| 9 | Decode Characters (check | Decoding the value of the string of bars checking: |
| | digit verified) | check digit, character/bar count, framing bars |

Address Block Data (excludes barcodes)

| | | |
|---|---|---|
| 10 | Address Format Accuracy | Checking if address data elements are formatted |
| | | correctly: OEL, Firm, Delivery Address, City-State |
| 11 | Address Component | Are any additional address components needed to |
| | Completeness | resolve the address; i.e. directional, secondary |
| | | address (apt #) |
| 12 | Readability | Checking if printed characters in Address are OCR |
| | | readable |
| 13 | Addressee Move update | Is the Addressee a move update candidate |
| 14 | Address Accuracy (Lookup | Does the applied POSTNET Barcode match the |
| | versus Applied POSTNET) | address directory lookup result.(If barcode is in the |
| | | address block) |
| 15 | Delivery Point Validation | Is the address current |
| 16 | ACS Readability | Checks ACS Participant and Keyline information |
| | | for content, format, location, and readability |

Other

| | | |
|---|---|---|
| 17* | Mailpiece Dimensions | Check size fits within processing category and |
| | | measure aspect ratio |
| 18 | Tray Label Readability | Bar by Bar and overall measurements as compared |
| | | to threshold measurements |
| 19 | Tray Label Decode | Decoding the value of the string of bars |
| | Characters | |

Mail piece 400 has a plurality of address components, including a return address block 420 and an address correction service (ACS) designation 422. As one point of analysis to be conducted by the service provider 200 on this mail piece 400, an ACS Readability analysis (16) may be performed (e.g., on the return address block 420). In addition, Address Format Accuracy (10), Address Component Completeness (11), Readability (12) analysis may also be performed on the return address block 420. Similar points of analysis may also be performed on the delivery address block 421, as well as Address Move Update (13), Delivery Point Validation (15), and Address Accuracy (14) analysis for determining if the delivery address block 421 matches the POSTNET Barcode 441 data. Also, other forms of analysis capable of being performed on the POSTNET Barcode 442 include Digit String Analysis (1), Barcode Readability (2), Barcode Location (3), etc. Similarly, various points of analysis may be performed on the PLANET Barcode 440 resident upon the mail piece 400.

The mail piece 400 also has an indicia marking, which in this case is representative of permit mail indicia 450. However, other acceptable forms of indicia may include a postage stamp 452 or a meter postage mark 451. Those skilled in the art will recognize that variations of indicia exist and are within the scope of the exemplary teachings herein. While not shown expressly in TABLE 1, a postage analysis may be performed on any applied indicia. The mail piece 400 also includes an endorsement line 423 (Optional Endorsement Line—OEL), which may be analyzed for Readability (12) and/or Address Format Accuracy (10). Finally, the mail piece 400 includes various custom markings, such as a marketing design or image 410 and marketing message or notice 411. The placement of such custom markings may be analyzed to ensure they comply with proper letter mail design criteria (e.g., ensuring that they are not improperly placed in a zone designated as a clear zone).

As discussed before, the various points of analysis identified above as being determinable via the exemplary teachings discussed herein correspond to analysis techniques employed by MDAs and/or any other persons or tools of analysis. One such tool for performing the analysis is shown in FIG. 5, which illustrates a mail piece design template 500 employed by the United States Postal Service (USPS)—i.e., registered USPS MDAs. This template 500 (described under Notice 67, Automation Letters Template of the Postal Explorer provided by the USPS website) is generally produced on translucent material, such as clear plastic so that it can be laid atop a mail piece, and provide a visual indication of compliance with given postal design requirements. So, for example, the POSTNET Barcode location, analysis point (3) in Table 1, may be analyzed through usage of the template 500 by visually inspecting that the barcode resides within the barcode placement field 502. Barcode Character decoding, analysis point (4), may be performed through the usage of the POSTNET DECODER guide 504 indicated on the mail piece. Mail piece dimensions may be verified—analysis point 17—through usage of the various dimensional guidelines 504, 506, 508, and/or ruler 510 made available by the template. In addition, other analysis points not expressly indicated in Table 1 may include facing identification mark (FIM) location verification 512 and FIM pitch quality 514. Today, the template 500 illustrated in FIG. 5 is implemented as a clear plastic sheet used by the USPS; however, the software implementation of the quality analysis tool can process mail piece image data (e.g. from a scanner or envelope reflectance measurement imaging device) so as to automate the comparison to standards represented by such a template.

For example, the template 500 allows the MDA to determine whether or not the mail piece complies with acceptable USPS dimensions. The MDA takes the clear template and lays it over the mail piece to do a “visual inspection”—checking to see if any of the mail pieces lay outside of the acceptable dimensional perimeter range. To reproduce this same functionality, the software tool 109 processes data for a received mail piece image to calculate the dimensions of the mail piece, and then it compares those dimensions against known control variables (acceptable USPS dimensions), e.g. corresponding to those shown on the template. If input mail piece dimensions are less than or equal to acceptable USPS dimensions, then the sample mail piece dimension test=PASS. IF not, then the mail piece dimension test=FAIL.

As another example, the template 500 allows the MDA to determine barcode skewing. The skewing of the barcode, be it PLANET or POSTNET, can be no more than 5% skewed from upright/vertical (90 degree) positioning. The MDA would overlay the template over the barcode(s) to determine if 5% skewing has occurred. The software tool 109 processes received data for a mail piece image to calculate the % skew from perfect vertical as indicated by the input image of the mail piece. If barcode skew is greater than 5%, skew test=FAIL. If not, skew test=PASS.

Those skilled in the art will recognize that various other criterion, analysis points, or techniques may be utilized for performing the mail piece quality analysis in a manner suitable for verifying its eligibility for machine automation. More importantly, it will be apparent to those skilled in the art that such techniques may be easily incorporated and employed via software in such a way as to eliminate any manual techniques or methods. In this regard, the aforementioned exemplary techniques and teachings discussed herein enable a user to perform quality analysis conveniently and efficiently. Furthermore, the teachings may be extended to cover other mailing types, such as automation flats mail quality analysis and the like (e.g., as described under Notice 124, Automation Flats Template of the Postal Explorer).

As shown by the above discussion, many of the functions relating to the mail piece quality and integrity analysis are implemented on one or more computers, which of course may be connected for data communication via the components of a network. The hardware of such computer platforms typically is general purpose in nature, albeit with an appropriate network connection for communication with other system elements or equipment and/or for communication via an intranet, the Internet and/or other data networks in the operational manner discussed in detail above.

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. In a terminal or workstation type implementation, such as a personal computer (PC) as might be used for the computer 106 in FIG. 1, the computer system also may be coupled to or include a display and one or more user input devices such as alphanumeric and other keys of a keyboard, a mouse a trackball, etc. The display and user input element(s) together form a service-related user interface, for interactive control of the operation of the computer system. Computer platforms running server application software, such as the computer 200 or 206 in FIG. 2, often will not directly include or connect to a display or user input device(s), although a server may be implemented by appropriate software running on a PC or the like with such user interface elements. If not included or locally connected, the interface elements may be provided at a remote location or device in communication with the computer platform via a network.

Those skilled in the art will recognize that the operations described above relating to the mail piece quality analysis may be carried out by processing of the data and/or associated execution of software, firmware, or microcode operating on the processors or computers that provide the functionalities of the servers and client devices shown in the system drawings. The code for implementing such operations may be in the form of computer instruction in any form (e.g. source code, object code, interpreted code, etc.) stored in or carried by any computer or machine readable medium.

In operation, the software (executable program code and/or the associated data) is stored within the general-purpose computer platform. At other times, however, the software may be stored at other locations and/or transported for loading into the appropriate general-purpose computer system. Several relevant communications between computer platforms are discussed above, by way of example, including loading of updates regarding applicable postal regulations for mail piece design rules or applicable acceptance standards.

Program aspects of the technology may be thought of a “products,” typically in the form of executable code and/or associated data that is carried on or embodied in a type of medium readable a computer or other machine. Media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. Hence, as used herein, terms such as computer or machine “readable medium” refer to any of the media discussed above or any other media that participates in providing instructions to a processor for execution or providing data to the processor for storage or processing or the like.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of performing mail piece quality analysis, for mail production quality assessment or quality control, the method comprising:
obtaining mail piece characteristic data, captured by sensing of one or more characteristics of a sample mail piece; and
executing quality analysis tool software in a computer to process the mail piece characteristic data, wherein the processing of the mail piece characteristic data comprises:
(a) identifying one or more characteristics of the sample mail piece from the mail piece characteristic data;
(b) analyzing quality of mail piece production by comparing the identified one or more characteristics of the sample mail piece to one or more mail piece quality requirements stored in the computer;
(c) generating a report of the quality of mail piece production indicating degree of compliance of the sample mail piece with the one or more mail piece quality requirements, based on a result of the comparison; and
(d) providing the report to a user associated with the mail piece production, for use in the mail production quality assessment or quality control.

2. The method of claim 1, wherein:
the obtaining of the mail piece characteristic data comprises operating a portable data capture device in a mail piece production or processing facility to sense the sample mail piece to capture the characteristic data regarding the sample mail piece; and
the executing of the analysis tool occurs in a computer associated with the mail piece production or processing facility.

3. The method of claim 2, wherein the computer associated with the mail piece production or processing facility is directly coupled to the portable data capture device in the mail piece production or processing facility.

4. The method of claim 2, wherein:
the computer associated with the mail piece production or processing facility is a server computer of an operator of the mail piece production or processing facility in communication with the portable data capture device; and
the providing of the report comprises sending the report from the server to a client computer of the user.

5. The method of claim 1, wherein:
the obtaining of the mail piece characteristic data comprises receiving the mail piece characteristic data at a website via a data network communication;
the executing of the analysis tool occurs in a computer associated with the website; and
the providing of the report to the user comprises sending the report back from the computer associated with the website through a data network communication to a computer of the user, for presentation to the user.

6. The method of claim 1, wherein the mail piece characteristic data comprises one or more items of information selected from the group consisting of:
information representing an image of the sample mail piece;
information obtained by measurement of reflectance of the sample mail piece; and
character information, representing information read from characters or symbols printed on the sample mail piece.

7. The method of claim 1, further comprising automatically updating the one or more mail piece quality requirements stored in the computer.

8. The method of claim 1, wherein the one or more mail piece quality requirements comprises a plurality of postal regulations for mail piece design.

9. The method of claim 1, wherein the one or more mail piece quality requirements comprises a plurality of postal regulations for mail piece acceptance standards.

10. A portable system for performing mail piece quality analysis, comprising:
a data capture device for sensing a sample mail piece to capture characteristic data regarding the sample mail piece, the data capture device being portable about a mail piece preparation or processing facility;
a portable computing device coupled to receive the captured characteristic data regarding the sample mail piece from the data capture device; and
quality analysis tool software stored in and executable by the portable computing device,
wherein execution of the analysis tool software by the computing device causes the computing device to perform functions comprising:
(a) identifying one or more characteristics of the sample mail piece from the mail piece characteristic data,
(b) analyzing the sample mail piece by comparing the one or more identified characteristics of the sample mail piece to one or more mail piece quality requirements, and
(c) generating a report of the quality of mail piece production indicating degree of compliance of the sample mail piece with the one or more mail piece quality requirements, based on a result of the comparison.

11. The system of claim 10, wherein the portable data capture device is a device selected from the group consisting of:
an envelope reflectance measurement imaging device for determining difference in reflectance between print on the sample mail piece and a background portion of the sample mail piece;
a scanner for scanning the sample mail piece to generate data representing an image of the sample mail piece; and
a reader for reading characters or symbols printed on the sample mail piece to generate data representing information carried by the characters or symbols printed on the sample mail piece.

12. The system of claim 10, wherein the one or more mail piece quality requirements used in the analysis during execution of the tool software comprises a plurality of postal regulations for mail piece design.

13. The system of claim 10, wherein the one or more mail piece quality requirements used in the analysis during execution of the tool software comprises a plurality of postal regulations for mail piece acceptance standards.

14. A portable system for performing mail piece quality analysis, comprising:
a data capture device for sensing a sample mail piece to capture characteristic data regarding the sample mail piece, the data capture device being portable about a mail piece preparation or processing facility;
a portable data device coupled to the data capture device and configured for implementing functions comprising:
(a) receiving the captured characteristic data regarding the sample mail piece from the data capture device;
(b) forwarding the captured characteristic data regarding the sample mail piece to a computer implementing quality analysis tool software to analyze the sample mail piece characteristic data for compliance of the sample mail piece with one or more mail piece quality requirements; and
(c) receiving and presenting to a user a report relating to quality of the sample mail piece based on level compliance with the one or more mail piece quality requirements.

15. The system of claim 14, wherein the data capture device is a device selected from the group consisting of:
an envelope reflectance measurement imaging device for determining difference in reflectance between print on the sample mail piece and a background portion of the sample mail piece;
a scanner for scanning the sample mail piece to generate data representing an image of the sample mail piece; and
a reader for reading characters or symbols printed on the sample mail piece to generate data representing information carried by the characters or symbols printed on the sample mail piece.

16. A web based mail piece quality analysis service provider system, comprising:
a data interface for communication via a network;
a programmable processing unit coupled to the data interface; and
storage, coupled to the processing unit, storing programming for the processing unit, including quality analysis tool software, and storing data regarding one or more mail piece quality requirements,
wherein execution of the programming by the processing unit causes the system to implement functions including:
(a) providing a website user interface via network communication;
(b) receiving via the website user interface, characteristic data regarding a sample mail piece from a data capture device having sensed the sample mail piece;
(c) identifying one or more characteristics of the sample mail piece from the mail piece characteristic data;
(d) analyzing the sample mail piece by comparing the one or more identified characteristics of the sample mail piece to one or more mail piece quality requirements from storage; and
(e) providing a report via the website user interface, the report indicating degree of compliance of the sample mail piece with one or more mail piece quality requirements, based on a result of the comparison.

17. The service provider system of claim 16, wherein the quality analysis tool software enables processing of one or more types of the characteristic data selected from the group consisting of:
information representing an image of the sample mail piece taken by the data capture device;
and character information, representing information read from characters or symbols printed on the sample mail piece by the data capture device.

18. The service provider system of claim 16, wherein the stored one or more mail piece quality requirements comprises a plurality a plurality of postal regulations for mail piece design.

19. The service provider system of claim 16, wherein the stored one or more mail piece quality requirements comprises a plurality of postal regulations for mail piece acceptance standards.
